(19) United States
(12) Patent Application Publication
(10) Pub. No.: US 2012/0134758 A1
(43) Pub. Date: May 31, 2012

(54) PRECISION PRESSING AND SINTERING OF CUTTING INSERTS, PARTICULARLY INDEXABLE CUTTING INSERTS

(76) Inventors: Bernd Bitterlich, Reichenbach/Fils (DE); Michael Fripan, Backnang (DE); Kilian Friederich, Plochingen (DE); Wolfgang Krümmel, Wetter/Ruhr (DE); Ulrich Mowlai, Stuttgart (DE); Andreas Schlagenhof, Plochingen (DE)

(21) Appl. No.: 13/388,679

(22) PCT Filed: Jul. 20, 2010
(86) PCT No.: PCT/EP2010/060494

§ 371 Date: Feb. 3, 2012

(30) Foreign Application Priority Data
Aug. 21, 2009 (DE) 10 2009 038 289.5
Sep. 10, 2009 (DE) 10 2009 029 326.4

(51) Int. Cl. B23B 27/14; C04B 35/10; B23B 27/16

(52) U.S. Cl. 407/113; 264/678

(57) ABSTRACT

A ready-for-use ceramic produced by sintering a blank and comprising an upper and a lower face, both of which have a support surface for mounting in a clamp mounting of a cutting tool, lateral faces connecting the upper and lower faces, and cutting edges which have chamfers.

The invention relates to a ready-for-use ceramic cutting insert for machining work pieces, produced by sintering a blank and comprising an upper and a lower face, both of which have a support surface for mounting in a clamp mounting of a cutting tool, lateral faces connecting the upper and lower faces, and cutting edges which have chamfers.

Up to now, the tight tolerances tor a ceramic cutting insert (e.g. in the case of the G tolerance ±25 μm at d=12.7 mm in the inscribed circle diameter, and ±130 μm for the thickness s) could only be set with diamond tools by regrinding after sintering, i.e. in the state in which the material has already developed all its excellent properties. Apart from the angles, radii and the cutting edge preparation of the indexable cutting inserts, a secure hold of the indexable cutting insert in the insert seat is also important. For this, adequate requirements regarding flatness of the support surface of the indexable cutting inserts have to be met. Up to now, these requirements could be achieved only by face grinding with diamond tools. This re-machining always involves high grinding forces and pressures, causing damage to the material.

It is an object of the invention to improve a ready-for-use cutting insert according to the preamble of the claim 1 in such a manner that re-machining after sintering is at least partially avoided. Moreover, a method for producing the cutting insert according to the invention shall be provided. In addition, a preferred use shall be presented.

In the following, the invention is illustrated in more detail by means of the claims.

In that the support faces of the upper and lower faces and/or the chamfers have at least subareas which consist of the sinter skin produced as a result of the sintering and which have not been damaged by any material-removing treatment, re-machining after sintering is at least partially avoided.

In a preferred embodiment, the entire upper and lower faces consist of the sinter skin produced during sintering. Since the sinter skin often has a higher hardness than the basis material, the wear resistance of the cutting material is thereby increased.

The more surface area of the cutting insert consists of the sinter skin produced during sintering, the higher is the hardness. Preferably, all chamfers therefore consist of the sinter skin produced during sintering.

Therefore, in one inventive configuration, individual lateral faces or preferably all lateral faces consist of the sinter skin produced during sintering.

Thus, a cutting insert according to the invention preferably meets the dimensional accuracy of the M tolerance according to ISO1382 and/or a dimensional accuracy of the G tolerance according to ISO1382.

For improving the mounting on a carrier tool, the upper and/or lower face of the cutting insert can have a recess or a continuous bore connecting the upper and lower faces.

Also, the upper and/or lower face and/or the lateral faces and/or the chamfers can be provided with a single- or multi-layered coating.

Preferably, the cutting insert consists of one or a plurality of the ceramic cutting materials mentioned below:
α-/β-SiAlONe with and without hard material reinforcement
β-Si3N4 with or without hard material reinforcement
Mixed ceramic (Al2O3-Ti(C, N))
ZTA (Al2O3-ZrO2)

Preferably, the cutting insert is an indexable cutting insert.

A method according to the invention for producing a ceramic cutting insert for machining work pieces, produced by sintering a blank and comprising an upper and a lower face, both of which have a support surface for mounting in a clamp mounting of a cutting tool, lateral faces connecting the upper and lower faces, and cutting edges which have a chamfer, is preferably characterized in that the blank of the cutting insert is brought into the desired shape by precision pressing, subsequently, the blank is sintered and after sintering, at least subareas of the support faces of the upper and/or lower face and/or the chamfer are not subjected to a material removing treatment.

Preferably, the entire upper and lower faces and/or all chamfers and/or all lateral faces are not subjected to a material removing treatment.

In one inventive configuration, a recess is pressed into the upper and/or lower face or a continuous bore connecting the upper and lower faces is pressed in by means of the precision pressing.

Preferably, for producing the blank, one or a plurality of the ceramic cutting materials mentioned below are used:
α-/β-SiAlONe with and without hard material reinforcement
β-Si3N4 with or without hard material reinforcement
Mixed ceramic (Al2O3-Ti (C, N))
ZTA (Al2O3-ZrO2)

A preferred method step is characterized in that the ceramic cutting materials are mixed into a compressible compound which has a high degree of flowability and therefore in particular a constant mold filling ability, wherein the angle of repose of the compound characterizing the flowability is to be set to less or equal 35°, preferred less or equal 30°, particularly preferred less or equal 25°.

Advantageously, all pressing burrs are removed from the blank prior to sintering without damaging the edges of the blank.

Preferably, the different pressing and shrinking behavior of different compound batches are considered, wherein through pressing and sintering trials, the green density-shrinkage characteristic, of each batch is determined and therefrom, the necessary production green density is specified and, when setting the presses, this production green density is set as a target value for the green density of the blanks.

Advantageously, the gas exchange during sintering between the furnace atmosphere and the crucible interior in which the blanks are sintered is minimized, and only crucible materials are used which are inert, i.e. do not interact in any way with the blanks during sintering.

Preferably, the cutting insert according to the invention is used for machining metals, plastics, wood or composite materials.

According to the invention, when producing indexable cutting inserts from high-performance ceramic materials by precision pressing and direct sintering, dimensions in compliance with the M and G tolerances according to ISO 1832 are achieved.

The inventive activity is therefore to bring the blank of the cutting insert, prior to the sintering and by precise pressing (also designated here as precision pressing), into such a shape which makes it possible that after sintering, no or only minimal regrinding of the upper and lower faces and/or the lateral faces of the finish-sintered cutting insert is necessary. The invention comprises a method for producing a cutting insert in which the blank of the cutting insert is brought into the desired shape by precision pressing, and the blank is subsequently sintered and thereby, the cutting insert is formed. According to the invention, no grinding or, in any case, less grinding is required after sintering. Preferably, at the same time, a recess is pressed into the cutting insert which makes it possible to clamp the cutting insert on a holder of a carrier tool.

The invention further describes a cutting insert with a sinter skin on the upper and/or lower face and/or lateral face and/or chamfer of the cutting insert. Preferably, these areas are or cover the entire upper and lower faces of the cutting insert.

The invention also describes a ceramic cutting insert or indexable cutting insert which meets the dimensional accuracy of the G tolerance according to ISO 1382, and the surfaces of which consist of the sinter skin produced during sintering and therefore were not subjected to a material-removing treatment.

The invention effects the following improvements when used:
Damage to the ceramic by grinding is avoided, i.e. reduced susceptibility of the products with regard to chipping and crumbling.
The “sinter skin” is maintained. Since the sinter skin often has a higher hardness than the basis material, the wear resistance of the cutting material is increased again, which in practice results in less flank wear and notch wear during machining.
Due to the reduced total wear on the indexable cutting insert and the resulting lower cutting forces, break-outs on the component can be reduced. The reduction of the cutting forces results also in a significantly reduced machine power consumption. Thereby, the distance to the threshold value of the cutting force monitoring system and the tool life per cutting edge is increased.
Advantageous is also a decrease in noise development during the use of the indexable cutting insert (WSP) according to the invention.

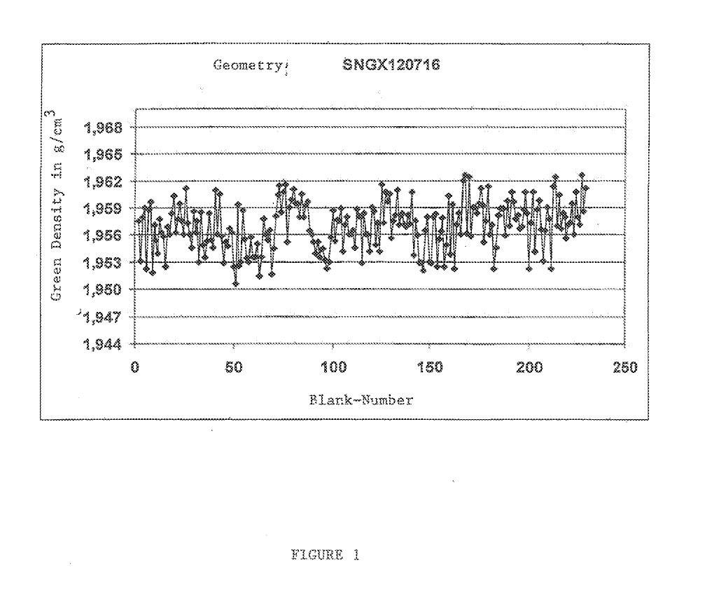

Different embodiments are conceivable:
Finish-pressed circumference: The outer contour of the cutting insert is pressed and sintered with high precision; the height (also called part height) of the WSP is still being ground and the edge is chamfered.
Finish-pressed height: The lateral faces obtain the correct dimension, e.g., through grinding, whereby the dimensional accuracy of the G tolerance is achieved in a simple manner. The upper and/or lower faces remain unground so that here the sinter skin is maintained. A chamfer can also be produced just by pressing or by grinding.
Finish-pressed: The outer contour and the part height are set to the correct dimension exclusively by pressing and sintering; cutting edge is chamfered (FIG. 1).
Highest embodiment: The chamfer too is set to the correct dimension by pressing and sintering.
Today's standard for comparison: Pressing and sintering of the blanks with a grinding allowance of one to several tenth of a millimeter; face grinding, peripheral grinding and chamfering are carried out on 3 different machines with different requirements. There are many possibilities where damage can be done to the material.

The invention relates to ail high-performance ceramic cutting materials, in particular:
α-/β-SiAlONe with and without hard material reinforcement, uncoated and coated. In particular here, an α-gradient and the associated near-surface hardness gradient are maintained.
β-Si3N4 with and without hard material reinforcement, uncoated and coated.
Mixed ceramic (Al2O3-Ti(C, N), uncoated and coated.
ZTA (Al2O3-ZrO2), uncoated and coated.

The invention is based in the following inventive ingenuity, and the following features during the production, alone or in combination, are advantageously to be considered:
When pressing the blank, advantageously, a very accurate and precisely centered gap between pressing punches and die are to be set. This can in particular be implemented by means of a quick-clamping system.
The pressing sequence is preferably set extremely accurate and with high reproducibility.
Compressible compound with a preferably very high degree of flowability and thereby constant mold filling ability. Flowability is characterized by the so-called angle of repose. For the measurement, a defined amount of pressing granulate is evenly poured into a transparent container. Then, the bottom plate is opened to some extent so that a portion of the powder flows out. Depending on the flowability of the granulate, the powder remaining in the container forms a more or less steep edge, the angle of which is measured as the angle of repose. For good flowability, the angle of repose should be less or equal 35°, preferred less or equal 30°, particularly preferred less or equal 25°.
A high degree of consistency of the green density of all blanks is necessary. This is achieved by a compound with very good flowability and a very accurately controlling press. Through an automatic mass and height measurement subsequent to the press, the green density of each pressed part can be calculated. The scatter of the green density from blank to blank should be less or equal 0.5%, preferably less or equal 0.3% of the mean value (example see FIG. 1: Production green density 1.956 g/cm³, green densities are within 1.951-1.963 g/cm³, target at max. 0.3% deviation; 1.951-1.962 g/cm³.
Removing the pressing burrs of the blank without damaging the edges. Due to the gap between the pressing punches and the dies, a thin burr remains on the blank. This burr has to be removed prior to sintering so that said burr is not sintered on the blank and subsequently can cause break-outs on the edge.
Considering the different pressing and shrinking behavior of different compound batches. Here, the green density-shrinkage characteristic of each batch is determined through pressing and sintering trials and therefrom, the necessary production green density is specified. When setting the presses, this production green density is used as a target value for the green density of the blanks.
Specific furnace structure to prevent distortion due to sintering, density gradients, shrinkage gradients and color gradients. In particular, the gas exchange between the furnace atmosphere and the crucible interior has to be minimized. In addition, only such crucible materials are to be used which are inert., i.e. do not interact in any way with the blanks during sintering. These measures are necessary in order to achieve a homogeneous shrinkage of the blanks during sintering. If, however, interactions between the blanks and the furnace atmosphere or the crucible material take place, the shrinkage of the blank is locally influenced so that a distortion during sintering takes place and the dimensional accuracy can no longer be ensured. If distortion due to sintering takes place, usually, mainly corners and edges of the parts placed at the periphery are affected. For example, in the case of silicon nitride or SiAlON materials, a high concentration of carbon in the gas atmosphere due to, e.g., new graphite materials of the crucible or the furnace insulation results in a reduction of the sinter additives on the surface, which are absolutely necessary for the densification. As a result, the shrinkage at the component periphery is smaller than in the center of the component, which results in distortion in the sintered component.

For a better clamping of the cutting insert, preferably, a recess is incorporated in the cutting inserts, as it is described in WO 03/013770. In the center, the recess has a spherical or circular elevation. The tip of the elevation lies above the recess bottom and below the upper face of the cutting insert. For clamping onto a cutting tool, a clamping claw having an adapted formed nose engages in a form fitting manner in the recess of the cutting insert. This recess serves for a form-fitting clamping on a carrier body. In particular for pulling cuts where, due to the acting cutting forces, the cutting insert could be pulled out of its seat, this cutting insert with the special recess is well suited. For a further description of this recess, see the mentioned printed matter.

In order that always constant mounting conditions are provided, in another embodiment according to the invention, the recess is configured in a manner as described in EP 1 536 903 B1. In this case, a first clamping recess is incorporated for clamping in the cutting tool, and coaxial to the first clamping recess, a second clamping recess is arranged, wherein the first clamping recess is deeper than the second clamping recess and both are arranged deeper than the upper face of the cutting insert. When clamping this cutting insert in a tool, a clamping claw of the tool rests on the second clamping recess and, for example, engages with a nose in the first clamping recess. The spacing between the support face of the clamping claw and the recess is therefore always constant.

The cutting insert according to the invention can also be provided with a single- or multi-layered coating.

FIG. 1 shows the minor scatter of the green densities from blank to blank. The scatter should be less or equal 0.5%, preferred less or equal 0.3% of the mean value. The production green density was approximately 1.956 g/cm³, the green densities were within 1.951-1.963 g/cm³, the target at max. 0.3% deviation; 1.951-1.962 g/cm³.

With the invention, under the same operating conditions, the notch wear is reduced, namely
Operation: Roughing a brake race
Cutting speed: Vc=1, 000 m/min
Cutting depth f=0.55 mm/revolution
Feed ap=3-4 mm
Material: GJL-alloyed
Tool life: 100 parts
Tool life criterion: Dimensional accuracy

In a trial, two indexable cutting inserts (WSP) with a recess for clamping in a holder of a cutting tool for material-removing machining were examined after reaching the tool life criterion. A coated PcBN indexable cutting insert according to the prior art was compared to an uncoated α-β-SiAlON WSP according to the invention.

The uncoated α-/β-SiAlON WSP according to the invention showed considerably less wear after reaching the tool life criterion than the PcBN WSP according to the prior art.

1-15. (canceled)

16. A ready-for-use ceramic cutting insert for machining work pieces, prepared by the process of sintering a blank and comprising an upper and a lower face, wherein each the upper face and the lower face have a support surface for mounting in a clamp mounting of a cutting tool, lateral faces connecting the upper and lower faces, and cutting edges which have chamfers, wherein the support faces of the upper and lower faces, the chamfers or both the chamfers and the support feces of the upper and lower faces have at least subareas which consist of the sinter skin produced as a result of the sintering and which have not been damaged by any material-removing treatment.

17. The cutting insert according to claim 16, wherein the entire upper and lower faces consist of the sinter skin produced during sintering.

18. The cutting insert according to claim 16, wherein all chamfers consist of the sinter skin produced during sintering.

19. The cutting insert according to claim 16, wherein individual lateral faces or preferably all lateral faces consist of the sinter skin produced during sintering.

20. The cutting insert according to claim 16, wherein the cutting insert meets at least one standard selected from the group consisting of the dimensional accuracy of the M tolerance according to ISO 1382 and the cutting insert meets a dimensional accuracy of the G tolerance according to ISO1382.

21. The cutting insert according to claim 16, wherein at least one of the upper face or the lower face has a recess or a continuous bore connecting the upper and lower faces.

22. The cutting insert according to claim 16, wherein at least one of the upper face, the lower face, the lateral faces or the chamfers are provided with a coating.

23. The cutting insert according to claim 16, wherein the cutting insert consists of at least one ceramic cutting material selected from the group consisting of
α-/β-SiAlONe with and without hard material reinforcement;
β-Si₃N₄ with or without hard material reinforcement;
mixed ceramic (Al2O3-Ti(C, N)); and
ZTA (Al2O3 - ZrO2).

24. A method for producing a ceramic cutting insert for machining work pieces, comprising sintering a blank and comprising an upper and a lower face, both of which have a support surface for mounting in a clamp mounting of a cutting tool, lateral faces connecting the upper and lower faces, and cutting edges which have a chamfer, wherein the blank of the cutting insert is brought into the desired shape by precision pressing, subsequently, the blank is sintered and after sintering, at least subareas of the support surfaces of the upper or lower faces or the chamfer are not subjected to a material removing treatment.

25. The method according to claim 24, wherein by precision pressing the blank, a recess is pressed into the upper or lower face or a continuous bore connecting the upper and lower faces is pressed in.

26. The method according to claim 24, wherein the blank comprises at least one member selected from the group consisting of
α-/β-SiAlONe with and without hard material reinforcement;
β-Si3N4 with or without hard material reinforcement;
mixed ceramic (Al2O3-Ti(C, N)); and
ZTA (Al2O3-ZrO2).

27. The method according to claim 24, wherein the ceramic cutting materials are mixed into a compressible compound which has a high degree of flowability and therefore in particular a constant mold filling ability, wherein the compound's angle of repose characterizing the flowability is to be set to less or equal 35°, preferred less or equal 30° and particularly preferred less or equal 25°.

28. The method according to claim 24, wherein prior to sintering, the pressing burrs of the blank are removed without damaging the edges of the blank.

29. The method according to claim 24, wherein the different pressing and shrinking behavior of different compound batches is considered, wherein through pressing and sintering trials, the green density-shrinkage characteristic of each batch is determined and therefrom, the necessary production green density is specified, and when setting the presses, said production green density is used as a target value for the green density of the blanks.

30. The method according to claim 24, wherein during sintering, the gas exchange between the furnace atmosphere and the crucible interior in which the blanks are sintered is minimized, and only crucible materials are used which are inert with the blanks.
